(19) United States
(12) Patent Application Publication
(10) Pub. No.: US 2007/0139587 A1
(43) Pub. Date: Jun. 21, 2007

(54) TRANSFLECTIVE LIQUID CRYSTAL DISPLAY PANEL, COLOR FILTER AND FABRICATING METHOD THEREOF

(76) Inventors: Chung-Hao Chen, Hsinchu County (TW); Yi-An Sha, Taipei City (TW); Chi-Chang Liao, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,869

(22) Filed: Feb. 26, 2006

(30) Foreign Application Priority Data
Dec. 21, 2005 (TW) 94145499

(51) Int. Cl. G02F 1/1335

(52) U.S. Cl. 349/106

(57) ABSTRACT

A transflective liquid crystal display (LCD) panel, a color filter and a fabricating method thereof are provided. The color filter includes a substrate, a light-shielding pattern, a plurality of thickness compensating patterns, and a plurality of color filter patterns. The light-shielding pattern is disposed on the substrate and defines a plurality of sub-pixel regions on the substrate. Wherein, each sub-pixel has a reflecting area and a transparent area. The thickness compensating patterns are disposed in the transparent area. Each of the color filter patterns is disposed in one of the sub-pixel regions and covers the thickness compensating pattern. Therefore, each color filter pattern has two different thicknesses in the reflecting area and the transparent area respectively. The color filter can improve the brightness uniformity and chroma uniformity of the images displayed in various sub-pixel regions of the transflective LCD panel.

### CROSS-REFERENCE TO RELATED APPLICATION

This application claims the priority benefit of Taiwan application serial no. 94145499, filed on Dec. 21, 2005. All disclosure of the Taiwan application is incorporated herein by reference.

### BACKGROUND OF THE INVENTION

1. Field of Invention

The present invention relates to a transflective liquid crystal display (LCD) panel. More particularly, the present invention relates to a color filter of a transflective LCD panel and the fabricating method thereof.

2. Description of Related Art

Along with the widespread of liquid crystal displays (LCD), the requirement of many portable electronic products to the display performance of LCDs has been gradually increased. For example, these portable electronic products require the LCD to maintain a suitable image quality in the environment with bright light as well as indoors. Thus, how to make LCDs to maintain a sharp display quality in environment with bright light has become one of the major trends in LCD development. Based on the reason described above, a transflective LCD is provided in conventional technology, which has sharp display effect both indoors and in outdoor bright environment.

FIG. 1 is a cross-sectional diagram of a conventional LCD unit. Referring to FIG. 1, the LCD unit 100 is a display unit of a transflective LCD panel (not shown), which includes a first substrate 110, a thin film transistor (TFT) 120, a dielectric layer 130, a reflecting electrode 140, a transparent electrode 150, a liquid crystal layer 160, a common electrode 182, a color filter pattern 184, and a second substrate 190. Moreover, the LCD unit 100 has a transparent area T and a reflecting area R.

As described above, the first substrate 110 and the second substrate 190 are glass substrates or plastic substrates. The TFT 120 and the dielectric layer 130 are both disposed on the first substrate 110, and the dielectric layer 130 covers the TFT 120. In addition, the reflecting electrode 140 and the transparent electrode 150 are both disposed on the dielectric layer 130 and are respectively located in the reflecting area R and the transparent area T. On the other hand, the color filter pattern 184 and the common electrode 182 are sequentially disposed on the surface of the second substrate 190 opposite to the first substrate 110. The liquid crystal layer 140 is disposed between the reflecting electrode 140, the transparent electrode 150, and the common electrode 182.

Referring to FIG. 1 again, the LCD unit 100 displays images in the transparent area T through the light provided by a back light module (not shown), while in the reflecting area R, the LCD unit 100 displays images through the external light, which is incident in the display and passes through the liquid crystal layer 160 and the color filter pattern 184 after being reflected by the reflecting electrode 140. Accordingly, the light has to pass the color filter pattern 184 twice in the reflecting area R to display images, while in the transparent area T, the light only passes the color filter pattern 184 once to display images. Thus, the brightness of the image displayed by the LCD unit 100 in the transparent area T is higher than that in the reflecting area R, but the color saturation of the image in the reflecting area R is higher than that in the transparent area T.

As shown in FIG. 2, to improve the brightness of the image in the reflecting area R, conventionally, a color filter 220 is provided. A color filter pattern 184 is disposed in the transparent area T and in the reflecting area R, a transparent photoresist layer 186b is disposed besides a color filter pattern 186a. Thus, in the reflecting area R, the external light penetrates both the color filter pattern 186a and the transparent photoresist layer 186b to cast on the reflecting electrode 140, and after reflected by the reflecting electrode 140, the light passes the color filter pattern 186a and the transparent photoresist layer 186b again. The problem of inadequate image brightness in the reflecting area R of the LCD unit 100 can be resolved because the transparent photoresist layer 186b disposed in the reflecting area R of the LCD unit 200 can reduce the filtered light of the light passing through the reflecting area R. However, chroma balance between the reflecting area R and the transparent area T cannot be achieved because the color filter 220 causes the white light in the reflecting area R of the LCD unit 200 to be too bright.

Besides, in the conventional technology, a color filter 320 is further provided as shown in FIG. 3. The color filter pattern 384 has two different thicknesses in a single display unit. In other words, the color filter pattern 384 in the reflecting area R is thinner than the color filter pattern 384 in the transparent area T, so that the differences between the two areas in the brightness and chroma of the images can be compensated. However, since the color filter pattern 384 of the color filter 300 is formed on the substrate 190 by spin coating, accordingly, two times of exposing processes have to be performed to form the dual thickness color filter (DTCF) 384 in FIG. 3, thus the process is complex and the cost is high.

### SUMMARY OF THE INVENTION

Accordingly, the present invention is directed to provide a color filter, which can resolve the problems of brightness ununiformity and chroma ununiformity between the transparent area and the reflecting area in transflective LCD.

According to another aspect of the present invention, a fabricating method for a color filter is provided to resolve the conventional problem of high fabricating cost of dual thickness color filter (DTCF).

According to yet another aspect of the present invention, a transflective LCD panel is provided to resolve the problem of ununiform brightness and ununiform chroma of images between reflecting display mode and transparent display mode.

To achieve the aforementioned and other objectives, the present invention provides a color filter including a substrate, a light-shielding pattern, a plurality of thickness compensating patterns, a plurality of color filter patterns, and a common electrode. Wherein, the light-shielding pattern is disposed on the substrate, and defines a plurality of sub-pixel regions on the substrate. Moreover, each of the sub-pixel regions has a transparent area and a reflecting area. Each thickness compensating pattern is disposed in the reflecting areas of one of the sub-pixel regions respectively, and each color filter pattern is disposed in one of the sub-pixel regions and cover the thickness compensating pattern respectively. The common electrode is disposed on the substrate and covers the color filter patterns and the thickness compensating patterns.

The present invention further provides a transflective liquid crystal display (LCD) panel, which includes an active matrix substrate, the foregoing color filter, and a liquid crystal layer. Wherein, the color filter is disposed above the active devices array substrate, and the liquid crystal layer is disposed between the color filter and the active devices array substrate.

In an embodiment of the present invention, the foregoing color filter patterns are formed in the sub-pixel regions by, for example, ink-jet process. Thus, each of the foregoing color filter patterns may further include a wall disposed on the light-shielding pattern, and the thickness of the wall is greater than the thickness of each thickness compensating pattern. In addition, the materials of the wall and the thickness compensating patterns may be same or different.

In an embodiment of the present invention, the foregoing thickness compensating patterns can be of regular shapes or irregular shapes. For example, the thickness compensating patterns are hemispheres or polygons.

The present invention provides a fabricating method for a color filter, which includes: forming a light-shielding pattern, which defines a plurality of sub-pixel regions, on a substrate first; next, forming a thickness compensating pattern in each of the sub-pixel regions; then forming a color filter pattern in each of the sub-pixel regions to cover the thickness compensating pattern.

In an embodiment of the present invention, the foregoing method of forming the color filter is, for example, ink-jet process. Moreover, a wall can be further formed on the light-shielding pattern after forming the light-shielding pattern and before forming the color filter patterns. The method of forming the wall is, for example, lithography process, ink-jet process, or press molding process. Wherein, the thickness of the wall is greater than the thickness of each thickness compensating pattern.

In an embodiment of the present invention, the foregoing wall and thickness compensating patterns are formed, for example, in the same process, and the formation method thereof, for example, includes: first, forming a photoresist layer covering the light-shielding pattern on the substrate; next, exposing the photoresist layer with a gray scale mask, wherein the gray scale mask has a light-shielding area, a transparent area, and a semitransparent area and the semitransparent area is located above the sub-pixel regions; after that, developing the photoresist layer to respectively form the wall and the thickness compensating patterns in the light-shielding pattern and the sub-pixel regions.

In an embodiment of the present invention, in the foregoing exposing process, the light-shielding area of the gray scale mask corresponds to the light-shielding patterns on the substrate.

According to the present invention, thickness compensating patterns are formed in the sub-pixel regions of a color filter so as to form the dual thickness color filters in the sub-pixel regions subsequently, so that the image displayed in each sub-pixel regions of the transflective LCD panel has uniform brightness and chroma.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1˜3 are cross-sectional diagrams of various conventional LCD units.

FIGS. 4A˜4D are cross-sectional diagrams illustrating the fabrication flow of a color filter according to an exemplary embodiment of the present invention.

FIGS. 5A˜5B are cross-sectional diagrams illustrating the flow to form the wall and the thickness compensating pattern in FIG. 4B.

FIGS. 6˜8 are partial cross-sectional diagrams of a transflective LCD panel according to exemplary embodiments of the present invention.

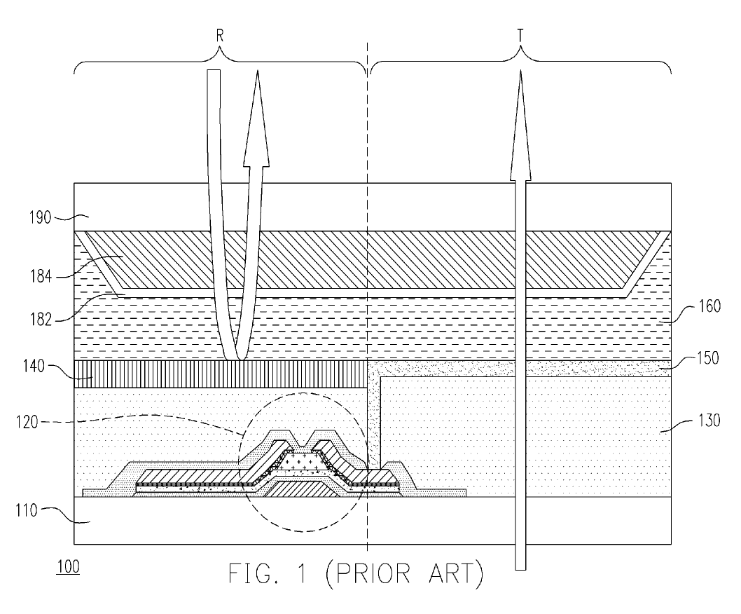

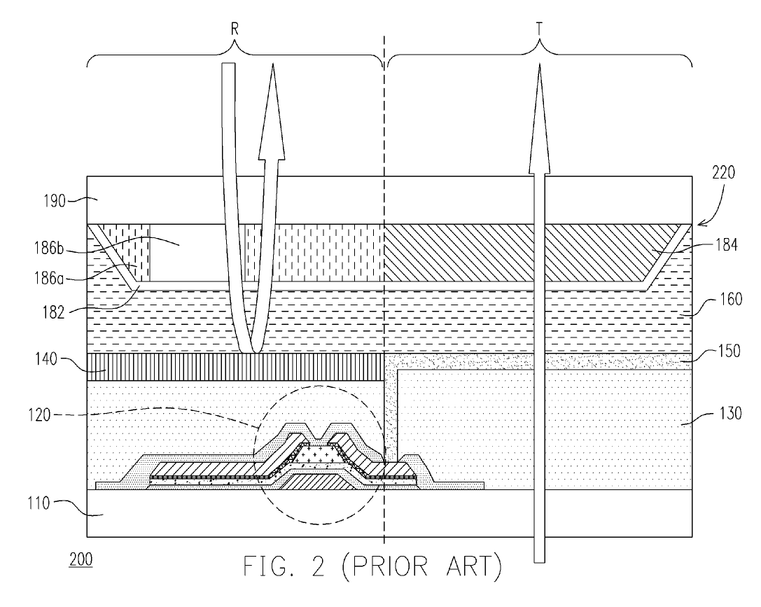

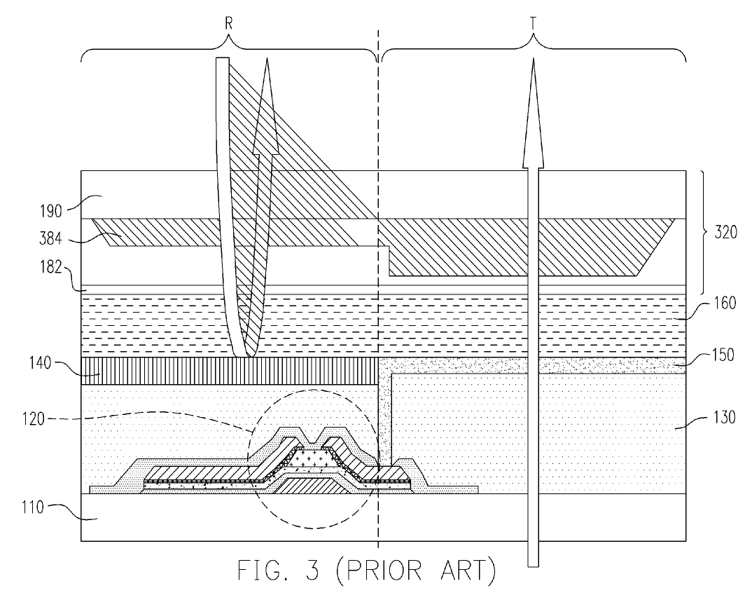

### DESCRIPTION OF EMBODIMENTS

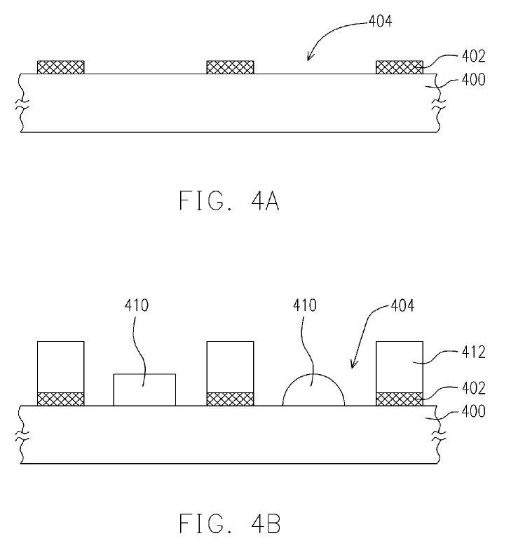

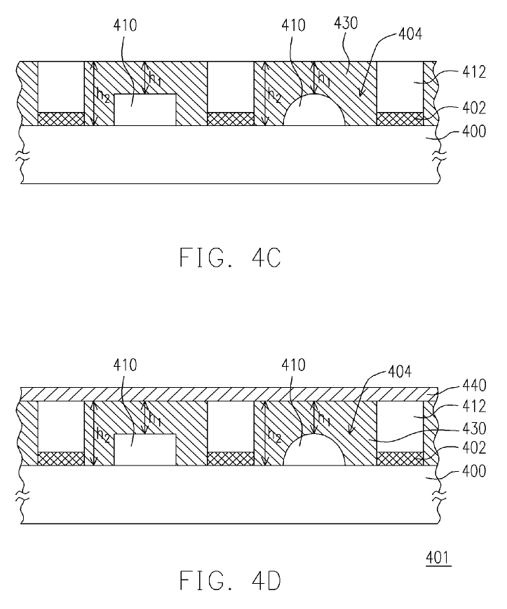

FIGS. 4A˜4D are cross-sectional diagrams illustrating the fabrication flow of a color filter according to an exemplary embodiment of the present invention. Referring to FIG. 4A first, a light-shielding pattern 402 is formed on a substrate 400, which defines a plurality of sub-pixel regions 404 on the substrate 400. Wherein, the light-shielding pattern 402 is a so-called black matrix (BM), and the material thereof is, for example, black resin, chromium, chromium oxide, or the composite thin film thereof.

Next, referring to FIG. 4B, a transparent thickness compensating pattern 410 is formed in each of the sub-pixel regions 404. Wherein, the thickness compensating patterns 410 are formed with, for example, lithography process, ink-jet process, or press molding process.

In the present embodiment, a color filter pattern is formed in each of the sub-pixel regions 404 with, for example, ink-jet process in subsequent process, and a wall 412 is formed on the light-shielding pattern 402, as shown in FIG. 4B, before performing the ink-jet process of forming the color filter patterns so as to avoid color mixing problem in the sub-pixel regions caused during the ink-jet process. Wherein, the material of the wall 412 and the material of the thickness compensating pattern 410 may be the same or different.

In particular, the foregoing thickness compensating patterns 410 are, for example, formed in the process of forming the wall 412. The method of forming the wall 412 and the thickness compensating patterns 410 together will be described below.

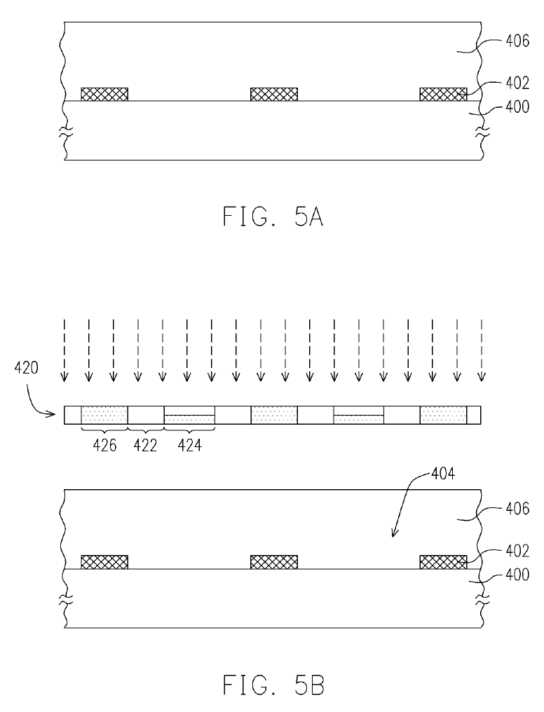

FIGS. 5A˜5B are cross-sectional diagrams illustrating the flow of forming the wall 412 and the thickness compensating patterns 410 in FIG. 4B. Referring to FIG. 5A, first, a photoresist layer 406 covering the light-shielding pattern 402, which has been formed on the substrate 400, is formed on the substrate 400. Wherein, the material of the photoresist layer 406 is transparent photoresist. Next, referring to FIG. 5B, the photoresist layer 406 is exposed with a gray scale mask 420. Wherein, the gray scale mask 420 has a transparent area 422, a semitransparent area 424, and a light-shielding area 426; the semitransparent area 424 is located above the sub-pixel regions 404, and the corresponding positions of the transparent area 422 and the light-shielding area 426 are determined by whether the photoresist layer 406 is positive photoresist or negative photoresist. For example, if the photoresist layer 406 is positive photoresist, then the light-shielding area 426 of the gray scale mask 420 is located above the light-shielding pattern 402 and the transparent area 422 thereof is located between the light-shielding area 426 and the semitransparent area 424 during the exposing process.

Next, the photoresist layer 406 is developed to remove the part of the photoresist layer 406 lit by light during the exposing process, so as to form the structure as shown in FIG. 4B. Wherein, during the exposing process in FIG. 5B, since the intensity of the light passing through the semitransparent area 424 of the gray scale mask 420 is smaller than the intensity of the light passing through the transparent area 422 thereof, the part of photoresist layer 406 corresponding to the semitransparent area 424 only becomes thinner instead of being removed completely after the developing process, and the remaining photoresist layer in each of the sub-pixel regions 404 is used as the thickness compensating pattern 410. On the other hand, since a part of photoresist layer 406 on the light-shielding pattern 402 is not lit by the light during the exposing process, this part of photoresist layer 406 is not removed during the developing process and remains on the light-shielding pattern 402 as the wall 412 after the developing process. Accordingly, the thickness of the wall 412 is greater than the thickness of the thickness compensating patterns 410.

In addition, in other embodiments, the wall 412 and the thickness compensating patterns 410 can also be formed in an ink-jet process or a press molding process simultaneously, and the foregoing embodiments are only used for describing the method of forming the wall 412 and the thickness compensating patterns 410 simultaneously, but not for limiting the present invention.

Moreover, in the present invention, the thickness compensating patterns 410 and the wall 412 are not limited to being fabricated in the same process; in other embodiments, the thickness compensating patterns 410 and the wall 412 can also be formed in different processes. Through increasing the thickness of the light-shielding pattern 402, the light-shielding pattern 402 can also function as a wall, so that it is not necessary to form the wall 412 on the light-shielding pattern 402 additionally.

Besides, the shapes or sizes of the thickness compensating patterns 410 are not limited in the present invention, which can be any regular or irregular shapes. For example, the thickness compensating patterns 410 can be polygons or hemispheres as shown in FIG. 4B.

Referring to FIG. 4C, the color filter patterns 430 are filled in the sub-pixel regions 404 after forming the wall 412 and the thickness compensating patterns 410. As described above, the color filter patterns 430 are formed with, for example, ink-jet process. Moreover, the color filter pattern 430 covers the thickness compensating pattern 410 in each sub-pixel region 404. Accordingly, the color filter pattern 430 in each sub-pixel region has two different thickness h₁ and h₂.

After that, referring to FIG. 4D, a common electrode 440 is formed on the substrate 400. Wherein, the common electrode 440 covers the color filter patterns 430 and the wall 412. Up to now the fabricating process of the color filter 401 has completed, and the characteristics of the color filter 401 will be described below with a transflective LCD panel as an example.

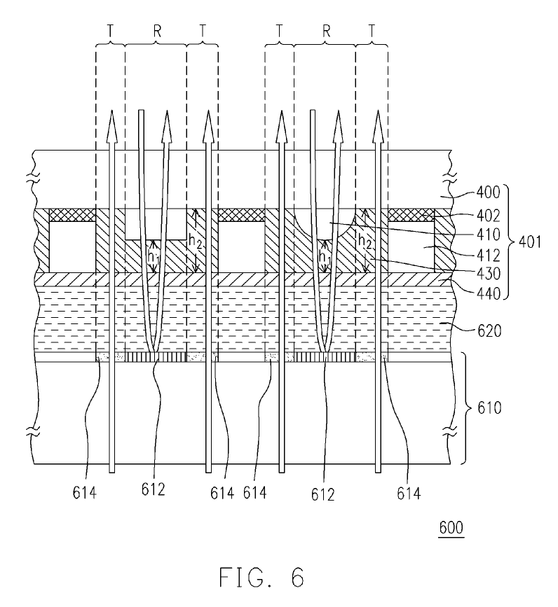

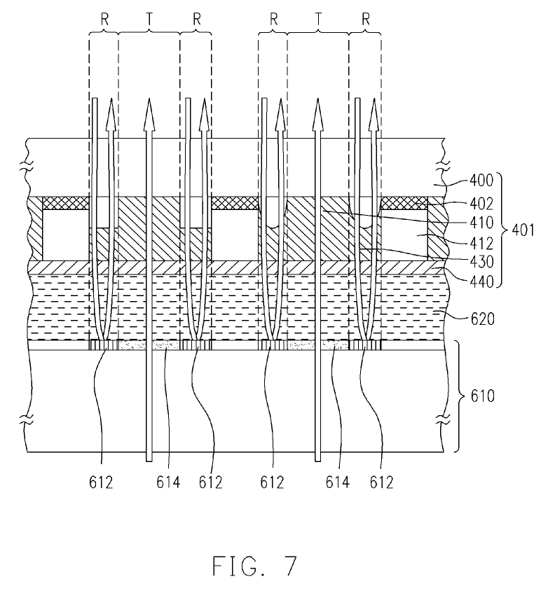

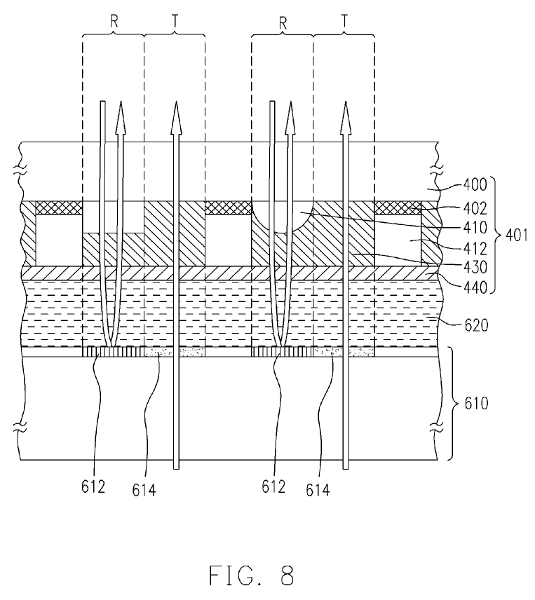

FIG. 6 is a partial cross-sectional diagram of a transflective LCD panel according to an exemplary embodiment of the present invention. Referring to FIG. 6, the transflective LCD panel 600 includes an active devices array substrate 610, a color filter 401, and a liquid crystal layer 620. Wherein, the color filter 401 is disposed on the active devices array substrate 610, and the liquid crystal layer 620 is disposed between the active devices array substrate 610 and the color filter 401.

As described above, each of the sub-pixel regions 404 of the color filter 401 has a reflecting area R and a transparent area T, and one thickness compensating pattern 410 is disposed in the reflecting area R. In other words, in the color filter 401, the thickness h₁ of the color filter pattern 430 in the reflecting area R is smaller than the thickness h₂ of the color filter pattern 430 in the transparent area T.

Here, the relative position of the reflecting area R and the transparent area T in each of the sub-pixel regions 404 is not limited in the present invention. As shown in FIG. 6, the reflecting area R can be located in the center of the sub-pixel region 404, and the transparent area T surrounds the reflecting area R. Certainly, as shown in FIG. 7, the transparent area T may also be located in the center of the sub-pixel region 404, and the reflecting area R surrounds the transparent area T. Alternatively, as shown in FIG. 8, the transparent area T is parallel to the reflecting area R. Moreover, the disposition position of the thickness compensating pattern 410 determines the relative position of the reflecting area R and the transparent area T. Accordingly, the disposition position of the thickness compensating patterns 410 in the sub-pixel regions 404 is not limited in the present invention.

On the other hand, it should be understood by those skilled in the art that a reflecting electrode 612 and a transparent electrode 614 are disposed in each sub-pixel region of the active devices array substrate 610 of the transflective LCD panel 600, wherein the reflecting electrode 612 corresponds to the reflecting area R of the color filter 401, and the transparent electrode 614 corresponds to the transparent area T of the color filter 401. In other words, the thickness h₁ of the color filter pattern 430 over the reflecting electrode 612 is smaller than the thickness h₂ of the color filter pattern 430 over the transparent electrode 614.

Referring to FIG. 6 again, in the transflective LCD panel, the light provided by the back light module (not shown) passes through the color filter pattern 430 in the transparent area T and is converted into required color light. On the other hand, the external light will be converted into required color light through the color filter pattern 430 in the reflecting area R after it penetrates the transflective LCD panel 600 and is reflected by the reflecting electrode 612. Here, since the thickness h₁ of the color filter pattern 430 in the reflecting area R is smaller than the thickness h₂ of the color filter pattern 430 in the transparent area T, even the light passing through the reflecting area R will pass the color filter pattern 430 twice, the brightness of the images displayed in the reflecting area R and the transparent area T can be made similar without affecting the color saturation of the image in the reflecting area R by controlling the proportion between h₁ and h₂ appropriately.

In overview, the present invention has the following advantages:

1. According to the present invention, the thickness compensating patterns are formed in the sub-pixel regions of the color filter so as to form dual thickness color filters in the sub-pixel regions subsequently. Thus, the images displayed in each sub-pixel regions of the transflective LCD panel of the present invention have uniform brightness and chroma.

2. According to the present invention, the thickness compensating patterns can be fabricated with the wall required by the ink-jet process for fabricating the color filter patterns simultaneously, thus the fabricating cost is reduced.

3. In the process of fabricating the color filter of the present invention, dual thickness color filters are formed with ink-jet process, thus, compared with the conventional spin coating method for forming dual thickness color filter, the present invention has the advantages such as lower process cost, higher efficiency in material utilization, and better production rate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color filter, comprising:
a substrate;
a light-shielding pattern, disposed on the substrate, defining a plurality of sub-pixel regions on the substrate, each of the sub-pixel regions having a transparent area and a reflecting area;
a plurality of thickness compensating patterns, each thickness compensating pattern is disposed in the reflecting area of one of the sub-pixel regions respectively;
a plurality of color filter patterns, each color filter pattern is disposed in one of the sub-pixel regions and covering the thickness compensating pattern respectively; and
a transparent common electrode, disposed on the substrate, covering the light-shielding pattern and the color filter patterns.

2. The color filter as claimed in claim 1, wherein the method of forming the color filter patterns includes ink-jet process.

3. The color filter as claimed in claim 2 further comprising a wall disposed on the light-shielding pattern, wherein the thickness of the wall is greater than the thickness of the thickness compensating patterns.

4. The color filter as claimed in claim 3, wherein the material of the wall and the material of the thickness compensating patterns are the same.

5. The color filter as claimed in claim 3, wherein the material of the wall and the material of the thickness compensating patterns are different.

6. The color filter as claimed in claim 1, wherein the thickness compensating patterns are of regular shapes or irregular shapes.

7. The color filter as claimed in claim 6, wherein the thickness compensating patterns are hemispheres or polygons.

8. A fabricating method of color filter, comprising:
forming a light-shielding pattern on a substrate, wherein the light-shielding pattern defines a plurality of sub-pixel regions on the substrate;
forming a thickness compensating pattern in each of the sub-pixel regions;
forming a color filter pattern in each of the sub-pixel regions, wherein each of the color filter patterns cover one of the thickness compensating patterns respectively; and
forming a common electrode on the substrate, the common electrode covering the color filter patterns.

9. The fabricating method as claimed in claim 8, wherein the method of forming the color filter patterns includes ink-jet process.

10. The fabricating method as claimed in claim 9 further comprising forming a wall on the light-shielding pattern before forming the color filter patterns and after forming the light-shielding pattern, and the thickness of the wall is greater than the thickness of the thickness compensating patterns.

11. The fabricating method as claimed in claim 10, wherein the method of forming the wall includes lithography process, ink-jet process, or press molding process.

12. The fabricating method as claimed in claim 10, wherein the wall and the thickness compensating patterns are fabricated in the same process.

13. The fabricating method as claimed in claim 12, wherein the method of forming the wall and the thickness compensating patterns comprises:
forming a photoresist layer on the substrate, the photoresist layer covering the light-shielding pattern;
exposing the photoresist layer with a gray scale mask, wherein the gray scale mask has a transparent area, a semitransparent area, and a light-shielding area, and the semitransparent area is located above the sub-pixel regions; and
developing the photoresist layer to form the wall and the thickness compensating patterns on the light-shielding pattern and in the sub-pixel regions of the substrate respectively.

14. The fabricating method as claimed in claim 8, wherein the method of forming the thickness compensating patterns includes lithography process, ink-jet process, or press molding process.

15. A transflective liquid crystal display (LCD) panel, comprising:
an active devices array substrate;
a color filter, disposed above the active devices array substrate, the color filter comprising:
a substrate;
a light-shielding pattern, disposed on the substrate, defining a plurality of sub-pixel regions on the substrate, each of the sub-pixel regions having a transparent area and a reflecting area;
a plurality of thickness compensating patterns, each thickness compensating pattern is disposed in the reflecting area of one of the sub-pixel regions respectively;
a plurality of color filter patterns, each color filter pattern is disposed in one of the sub-pixel regions and covering the thickness compensating pattern respectively;
a transparent common electrode, disposed on the substrate and covering the light-shielding pattern and the color filter patterns; and
a liquid crystal layer, disposed between the active devices array substrate and the color filter.

16. The transflective LCD panel as claimed in claim 15, wherein the color filter further comprises a wall disposed on the light-shielding pattern, and the thickness of the wall is greater than the thickness of the thickness compensating patterns.

17. The transflective LCD panel as claimed in claim 16, wherein the material of the wall and the material of the thickness compensating patterns are same or different.

18. The transflective LCD panel as claimed in claim 15, wherein the thickness compensating patterns are of regular shapes or irregular shapes.

19. The transflective LCD panel as claimed in claim 18, wherein the thickness compensating patterns are hemispheres or polygons.
